(19) United States
(12) Patent Application Publication
(10) Pub. No.: US 2014/0204701 A1
(43) Pub. Date: Jul. 24, 2014

(54) APPARATUS AND METHOD FOR DETERMINATION OF FAR-FIELD SIGNATURE FOR MARINE SEISMIC VIBRATOR SOURCE

(71) Applicant: CGG SERVICES SA, Massy Cedex (FR)

(72) Inventor: Benoit TEYSSANDIER, Massy (FR)

(73) Assignee: CGG SERVICES SA, Massy Cedex (FR)

(21) Appl. No.: 14/069,483

(22) Filed: Nov. 1, 2013

(30) Foreign Application Priority Data
Jan. 24, 2013 (FR) 1350638

(51) Int. Cl. G01V 1/04; G01V 1/34

(52) U.S. Cl. CPC G01V 1/04; G01V 1/34; G01V 1/38
USPC 367/7; 367/15

(57) ABSTRACT

Computing device, system and method for calculating a far-field signature of a vibratory seismic source. The method includes determining an absolute acceleration of a piston of the vibratory seismic source while the vibratory seismic source generates a seismic wave; calculating, based on the absolute acceleration of the piston, a far-field waveform of the vibratory seismic source at a given point (O) away from the vibratory seismic source; and cross-correlating the far-field waveform with a driving pilot signal of the vibratory seismic source to determine the far-field signature of the vibratory seismic source.

### BACKGROUND

1. Technical Field

Embodiments of the subject matter disclosed herein generally relate to methods and systems and, more particularly, to mechanisms and techniques for determining a far-field signature of a marine vibratory source.

2. Discussion of the Background

Reflection seismology is a method of geophysical exploration to determine properties of a portion of a subsurface layer in the earth; such information is especially helpful in the oil and gas industry. In marine seismic prospection, a seismic source is used in a body of water to generate a seismic signal that propagates into the earth and is at least partially reflected by subsurface seismic reflectors. Seismic sensors located at the bottom of the sea, or in the body of water at a known depth, record the reflections, and the resulting seismic data may be processed to evaluate the location and depth of the subsurface reflectors. By measuring the time it takes for the reflections (e.g., acoustic signal) to travel from the source to plural receivers, it is possible to estimate the depth and/or composition of the features causing such reflections. These features may be associated with subterranean hydrocarbon deposits.

For marine applications, seismic sources are essentially impulsive (e.g., compressed air is suddenly allowed to expand). One of the sources most used is airguns which produce a high amount of acoustic energy over a short time. Such a source is towed by a vessel either at the water surface or at a certain depth. Acoustic waves from the airgun propagate in all directions. A typical frequency range of the emitted acoustic waves is between 6 and 300 Hz. However, the frequency content of the impulsive sources is not fully controllable, and different sources are selected depending on a particular survey's needs. In addition, use of impulsive sources can pose certain safety and environmental concerns.

Thus, another class of sources may be used, such as vibratory sources. Vibratory sources, including hydraulically- or electrically-powered sources and sources employing piezoelectric or magnetostrictive material, have been previously used in marine operations. Such a vibratory source is described in patent application Ser. No. 13/415,216, (herein '216) “Source for Marine Seismic Acquisition and Method,” filed on Mar. 8, 2012, the entire content of which is incorporated herein by reference, and this application is assigned to the assignee of the present application. A positive aspect of vibratory sources is that they can generate acoustic signals that include various frequency bands. Thus, the frequency band of such a source may be better controlled, compared to impulsive sources.

A representation of the acoustic pressure generated by a source (impulsive or vibratory), known as a far-field waveform, may be measured or calculated. Based on the far-field waveform, a signature (far-field signature) of the source may be defined. The signature of a source is desired, as will be discussed later. For example, European Patent Application EP0047100B1, “Improvements in/or relating to determination of far-field signatures, for instance of seismic sources,” the entire content of which is incorporated herein by reference, presents a method applicable to airguns for determining the far-field signature generated by an array of several units. Each unit is provided with its “near-field hydrophone” located at a known distance from the source. The method sequentially fires all units (i.e., when one unit is fired, the other units are not fired) located in the array, which implies that interactions between units are neglected. By knowing some environmental parameters (reflection at sea/air interface, source depth, etc.), the far-field signature can be estimated by summation of the individual source unit's signatures as detected by each near-field hydrophone and by taking into account (synthetically) the ghost effect.

U.S. Pat. No. 4,868,794, “Method of accumulation data for use in determining the signatures of arrays of marine seismic sources,” presents a similar method as discussed above. However, this method provides the far-field signature of an array when all units are fired synchronously, which implies that the interactions between sources are taken into account. Each seismic unit can be represented by a notional near-field signature given by post-processed near-field data. The far-field signature array estimate can then be determined at any desired point below the sea surface, and not only along the vertical axis generally used for direct far-field measurement. However, there is a problem with this method: When a near-field sensor is used to determine the sound pressure of a given source unit, that near-field sensor also detects sound pressures from other source units and their interactions. Thus, a processing step (for determining the notional near-field signature) is necessary to separate the sound pressures from the other source units and to remove these components. Because this processing step is time-consuming and may introduce inaccuracies, not having to perform this step is desirable.

Another technique described in GB 2,468,912, “Processing seismic data,” the entire content of which is included herein by reference, presents a method for providing quantitative error in far-field signature estimation by using both the method described above (based on notional near-field signature) and data measured at specific receiver points along streamers. These data are compared and can show if any errors notional signatures estimation can lead to errors in the far-field signature estimation.

Determining the far-field signature, which is representative of a portion of the acoustic signal received by the seismic sensor, is important for a de-signature procedure because, traditionally, an estimate of the far-field signature is used to deconvolve the recorded seismic data to minimize interference and/or to obtain zero-phase wavelets. This process is known as de-signature.

However, the methods discussed above suffer from one or more disadvantages. For example, if the near-field sensor is used to record the near-field signature, the measurement may not be accurate or the sensor may fail. If a far-field sensor is used (which should be located at a minimum depth which varies in the seismic community, however, an example is least 300 m below the source), the equipment for such measurements is expensive and not always reliable. Methods that do not rely on a sensor but use various models to calculate the far-field signature are not accurate and require intensive and time-consuming processing steps. Also, they may not be applicable for shallow water applications.

Thus, it is desired to obtain the far-field signature of a marine source with minimum additional equipment, in a reliable way, based on real, rather than estimated, data to overcome the afore-described problems and drawbacks.

### SUMMARY

According to one exemplary embodiment, there is a method for calculating a far-field signature of a vibratory seismic source. The method includes a step of determining an absolute acceleration of a piston of the vibratory seismic source while the vibratory seismic source generates a seismic wave; and a step of calculating, based on the absolute acceleration of the piston, a far-field waveform of the vibratory seismic source at a given point (O) away from the vibratory seismic source.

According to another exemplary embodiment, there is a method for calculating a far-field signature of a vibratory seismic source array. The method includes a step of determining absolute accelerations of pistons of individual vibratory seismic sources of the vibratory seismic source array while the individual vibratory seismic sources generate seismic waves; and a step of calculating, based on the absolute accelerations of the pistons, a far-field waveform of the vibratory seismic source array at a given point (O) away from the vibratory seismic source array.

According to still another exemplary embodiment, there is a computing device for calculating a far-field signature of a vibratory seismic source. The computing device includes an interface for receiving an absolute acceleration of a piston of the vibratory seismic source while the vibratory seismic source generates a seismic wave; and a processor connected to the interface. The processor is configured to calculate, based on the absolute acceleration of the piston, a far-field waveform of the vibratory seismic source at a given point (O) away from the vibratory seismic source, and cross-correlate the far-field waveform with a driving pilot signal of the vibratory seismic source to determine the far-field signature of the vibratory seismic source.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a seismic survey system that uses a far-field sensor for determining a far-field signature of a seismic source;

FIG. 2A illustrates an individual vibratory seismic source having two pistons according to an exemplary embodiment;

FIG. 2B is a schematic representation of a monopole model for a seismic vibratory source;

FIG. 3A illustrates an individual vibratory seismic source having a sensor on a piston for measuring an acceleration of the piston according to an exemplary embodiment;

FIG. 3B illustrates a movement of a piston of a seismic vibratory source;

FIG. 4 is a schematic illustration of a seismic vibratory source array according to an exemplary embodiment;

FIG. 5 is a schematic illustration of a seismic vibratory source array and a corresponding virtual array that is taken into account when calculating a far-field waveform according to an exemplary embodiment;

FIGS. 6A-B are schematic illustrations of a process for obtaining a far-field wavelet according to an exemplary embodiment;

FIG. 6C is a schematic illustration of another process for obtaining a far-field wavelet according to an exemplary embodiment;

FIG. 7 is a flowchart of a method for determining a far-field wavelet according to an exemplary embodiment;

FIG. 8 is a schematic diagram of a computing device in which the above method may be implemented according to an exemplary embodiment; and

FIG. 9 is a schematic diagram of a curved streamer.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of an acoustic source unit having two oppositely-driven pistons. However, the embodiments to be discussed next are not limited to this type of vibratory source, but may be applied to other seismic sources that have one piston or more than two pistons.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an exemplary embodiment, there is a method for calculating a far-field signature of a vibratory seismic source. The method includes a step of determining an acceleration of a piston of the vibratory seismic source while the vibratory seismic source generates a seismic wave; a step of calculating, based on the acceleration of the piston, a far-field waveform of the vibratory seismic source at a given point (O) away from the vibratory seismic source; and a step of cross-correlating the far-field waveform with a driving pilot signal of the vibratory seismic source to determine a far-field signature of the vibratory seismic source. The same novel concept may be applied to a seismic vibratory source array that includes plural individual vibratory sources.

For clarity, note that for an impulsive source (e.g., an air gun), the far-field waveform and the far-field signature may be used interchangeably. However, for a vibratory seismic source, these two concepts are different. A far-field waveform is considered to be an estimate of the resultant source array pressure at a remove point in the sea under the condition that the source is operating in the water with only the effect of the air/water boundary reflection included and no earth or sea or subterranean earth features or reflection multiples included. The far-field signature is a more general quantity, for example, the correlation of the far-field waveform with another signal. For the particular case when the another signal is the pilot signal and/or the ghost pilot signal, the result of this correlation is the far-field wavelet (a particular case of far-field signature). Other mathematical procedures then a correlation may be envisioned by those skilled in the art to define the far-field signature of a vibrationary source.

During a seismic survey, the measurable response T(t) (the signal recorded with a seismic sensor) is considered to be composed of the impulse response of the earth G(t) convolved with the earth attenuation E(t) and the far-field waveform P(t) of the seismic source, plus some noise N(t). This can be translated mathematically into:

T(t)=[P(t)*G(t)*E(t)]+N(t), (1)

where “*” represents the convolution operator.

An initial seismic data processing step attempts to recover the earth impulse response G(t) from the measurable quantity T(t). To achieve this, the signal-to-noise ratio needs to be large enough and the shape of the far-field waveform P(t) needs to be known. Thus, monitoring the far-field waveform is necessary to have access to the impulse response of the earth, irrespective of what kind of seismic source technology is used.

Impulsive energy sources, such as airguns, allow a large amount of energy to be injected into the earth in a very short period of time, while a marine seismic vibratory source is commonly used to propagate energy signals over an extended period of time. The data recorded in this way is then cross-correlated to convert the extended source signal into an impulse (wavelet, as discussed later).

As discussed in the Background section, the far-field waveform can be recorded with far-field sensors (hydrophones) located beneath the source at a sufficient depth in order to have access to the far-field radiation of the source. This is true regardless of the kind of seismic source technology used.

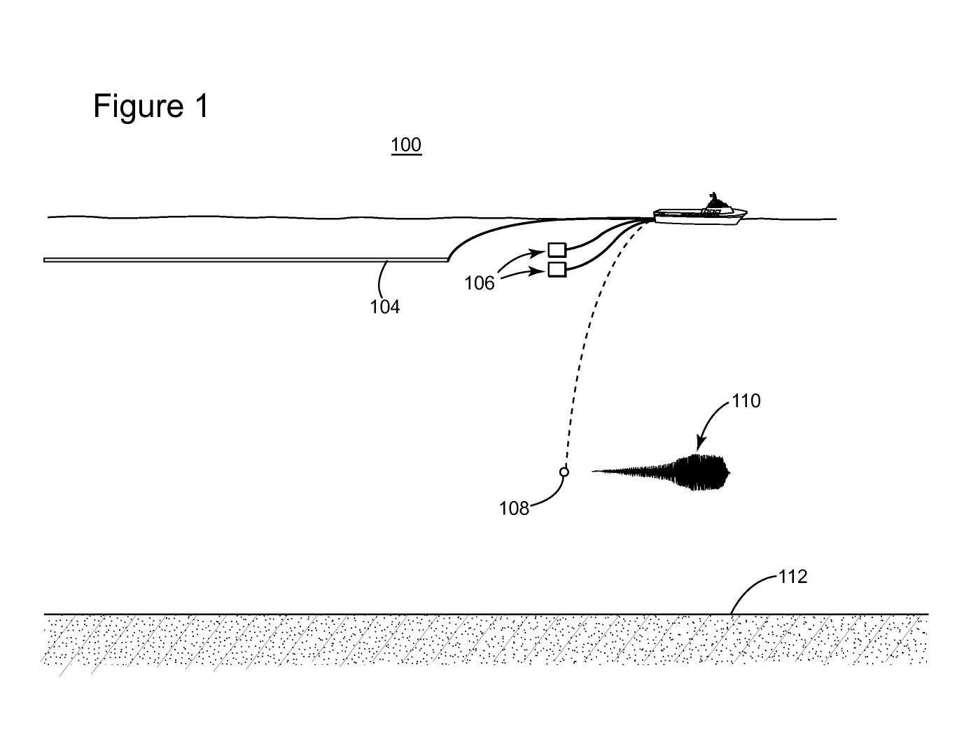

Such a system 100 is illustrated in FIG. 1. The system 100 includes a vessel 102 that tows one or more streamers 104 and a seismic source 106. The seismic source 106 may be any of the sources discussed above. In this embodiment, the seismic source 106 is an over/under source, i.e., a source that has one part that emits a signal in a first frequency band and one part that emits a signal in a second frequency band. The two frequency bands may be different or they may overlap. The system 100 further includes a sensor 108 for acquiring the source's far-field waveform. Note that the source may include one or more independent source points (not shown). For example, if the source is an airgun array, the array includes plural individual airguns. The same may be true for a vibratory source. The sensor 108 records the energy generated by the source 106, i.e., the far-field waveform 110 of the source.

However, this approach presents several disadvantages. If the seismic system is a towed system, as illustrated in FIG. 1, vibrations of the cables involved in towing the probe can be perceived by the far-field sensors as a signal generated by the acoustic source, and thus, the seismic recordings are polluted by such perturbations.

Another disadvantage of using far-field sensors for determining the far-field waveform is the need to have the sensors at a given depth (e.g., 300 m) beneath the source. Thus, when a shallow-water seismic survey (typically less than 100 m) needs to be performed, the sensors cannot be placed at the required depth to determine the far-field waveform because the sea bed 112 is too close to the source 106.

Further, this technique provides only a vertical signature, which is useful most of the time, but not enough in some situations. Furthermore, the ghost function introduced by direct radiation of the source plus the reflection on the sea/air interface is not fully developed when the far-field sensors are located in the vicinity of 500 m. This means that the vertical signature contains estimate errors and is not the source's true vertical far-field signature.

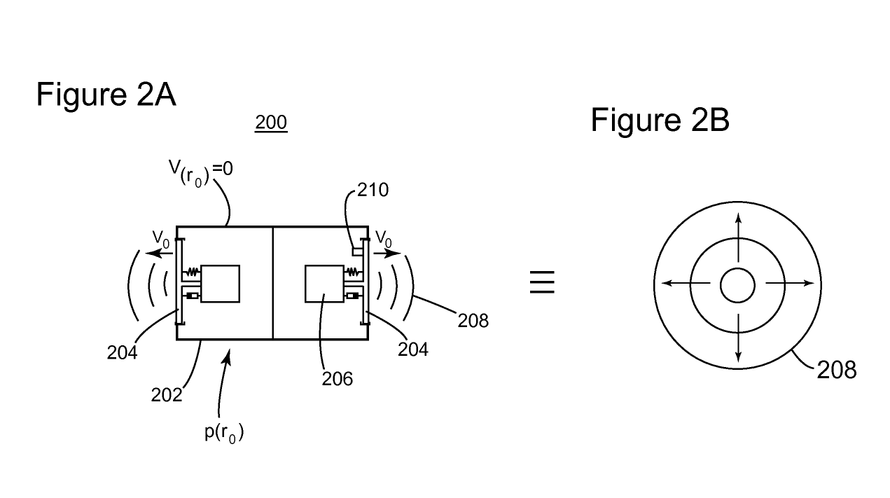

The above-noted problems may be eliminated if a vibratory source is used and a novel method for calculating the far-field signature is implemented, as discussed next. FIG. 2A shows a seismic vibratory source 200. This source may be the source disclosed in patent application '216 or another vibratory source. Consider the vibratory source 200 as having a housing 202 with two openings that accommodate two pistons 204. The pistons 204 may be actuated (simultaneously or not) by a single or plural actuators 206. The actuator 206 may be an electromagnetic actuator or another type (e.g., pneumatic). The back-and-forth movement of the pistons 204, as actuated by the actuator 206, generates the acoustic signal 208. Such a source may be modeled with a monopole as illustrated in FIG. 2B, i.e., a point source that emits a spherical acoustic signal 208, if the two pistons have the same area and are synchronized/controlled so that they both extend equally outward together and inward together, and if the radiated wavelength is large relative to the source dimensions

This is different from traditional marine vibratory sources in which a single piston is actuated and, for this reason, these sources are modeled as a combination of a monopole source and a dipole source. The presence of a single piston makes the marine vibratory source mechanical model take into account both a baseplate and a reaction mass (see Baeten et al., “The marine vibrator source,” First Break, vol. 6, no. 9, September 1988, the entire content of which is incorporated herein). For the source illustrated in FIG. 2A, that model is not applicable because there is no need for a reaction mass. Thus, the mathematical formulae used to determine the far-field signature are different, as discussed later.

A sensor 210 may be located on the piston 204 for determining its acceleration. FIG. 2A shows the sensor 210 mounted inside the housing 202. In one application, the sensor 210 may be mounted on the outside of the piston. Sensor 210 may also be mounted on a component of the actuator 206, e.g., the rod that actuates the piston if the guiding system is rigid enough. In one embodiment, the actuator 206 is rigidly attached to the housing 202.

Regarding the acceleration measured with the sensor 210, the following discussion is believed to be in order. According to an exemplary embodiment, it is desired to measure the piston's acceleration relative to an earth related reference point so that the true acceleration of the volumetric change of the device is determined. In other words, the piston's acceleration relative to the earth (absolute acceleration) and not relative to the source's housing (relative acceleration) is the quantity to be used in the calculations below. Thus, if the housing has its own acceleration, a sensor located on the piston may measure the piston's acceleration relative to the housing and not the absolute acceleration. If the system measures the piston's acceleration relative to the free space and the housing is being towed and subject to towing noise, this would be measured by an accelerometer whose reference is a fixed point in space. This noise can be rejected by using, for example, a differential acceleration measurement (accelerometer of piston—acceleration of housing). To determine the piston's absolute acceleration, the source's acceleration needs to be calculated. The source's acceleration may be measured with known methods and this acceleration may be added or subtracted from the piston's measured acceleration to determine the piston's absolute acceleration.

For the case of the twin driver illustrated in FIG. 2A, it is assumed that the two back to back actuators 206 are perfectly matched. However, this may not be the case. Thus, a measurement of the two piston accelerations relative to the housing will tend to reject this imbalance in the measurement. The imbalance is not an efficient producer of acoustic energy since it acts like a dipole. Also the twin driver is towed and subject to towing vibration.

To estimate differential acceleration, devices like Linear Variable Differential Transformer (LVDT) sensors could be used and they may be mounted between the piston and the housing and then, their output, may be twice differentiated in time. For example, a first component may be fixedly attached to the piston and a second component of the sensor may be fixedly attached to the housing to determine the relative acceleration of the piston to the housing. Then, another sensor mounted on the housing may be used to determine the acceleration of the housing relative to earth. Alternatively, even velocity transducers may be used and their output differentiated once to get to differential acceleration.

The seismic signal 208 generated by a seismic vibratory source may be a sweep signal of continuously varying frequency, increasing or decreasing monotonically within a frequency range, and can present an amplitude modulation. Other types of signals, e.g., non-linear, pseudo-random sequences, may also be generated.

The sound pressure generated by the source shown in FIG. 2A may be calculated as next discussed, using the Helmholtz integral formula:

$$p ( r , ω ) = \frac{1}{4 π} \int {\int }_{S} [ \frac{{e}^{j k \vert r - {r}_{0} \vert}}{\vert r - {r}_{0} \vert} jωρ {V}_{n} ( {r}_{0} ) + p ( {r}_{0} ) \frac{d}{d n} ( \frac{{e}^{- j k \vert r - {r}_{0} \vert}}{\vert r - {r}_{0} \vert} ) ] d {S}_{0} , \qquad ( 2 )$$

where |r−r₀| is the distance from a point located on the surface of the source referred to as r₀ to a point where the sound pressure p is calculated referred to as r, S is area of the entire source including the pistons, k is a wavenumber, j square is −1, ω is the frequency, V is the normal velocity distribution on the source, n is the normal to the surface of the entire source, and ρ is the density of the fluid (water in this case). Note that equation (2) has two terms inside the bracket, the first one corresponding to monopolar radiation and the second one to dipolar radiation. In one application, there is a plurality of individual sources that form the source array and the individual sources may have different accelerations, piston shapes, masses, etc. For this situation, it is possible to measure each individual source's acceleration and then to combine these accelerations using a weighted sum of the acceleration signals from all the pistons as a far-field signature estimate. In one application, the weighting is made to be proportional to the piston area.

Equation (2) is valid everywhere in the fluid, at any point outside the boundary. However, when the far-field is calculated and when it is assumed that the radiated wavelength λ is much larger than the typical length l of the source 202, thus the dipole radiation term may be ignored. Thus, the far-field waveform of a twin source unit as illustrated in FIG. 2B is equivalent to the radiation of two point sources (one point source per piston). The sound pressure for a point source then becomes:

$$p ( r , t ) = jω \frac{ρ Q}{4 π r} {e}^{- j k \cdot r} {e}^{jω t} = p ( r , ω ) {e}^{jω t} . \qquad ( 3 )$$

The sound pressure amplitude is:

$$\vert p ( r , ω ) \vert = \frac{ωρ Q}{4 π r} , \qquad ( 4 )$$

and the sound pressure phase is given by:

∠p(r,ω)=k·r˜Φ, (5)

where Q is the source strength (i.e., the product of the vibrating source area and the normal velocity on the boundary for a monopole) with units [m³/s] and can be expressed as:

Q=∫∫_{S}V(r)·ndS, (6)

with n being the unit vector, which is normal to the surface of the piston, and dS being an area element on the surface of the piston.

For a flat circular piston, Q=V₀×Sₚ, where V₀ is the piston velocity and Sₚ is the piston area. Because the velocity (of the piston) has a homogeneous normal distribution over the flat piston that moves with velocity V₀, the area Sₚ of the piston is given by πR², where R is the radius of the piston. Thus, the pressure amplitude is given by:

$$\vert p ( r , ω ) \vert = \frac{ωρ {V}_{0} {S}_{p}}{4 π r} = \frac{ρ {AS}_{p}}{4 π r} , \qquad ( 7 )$$

with A being the acceleration of the piston.

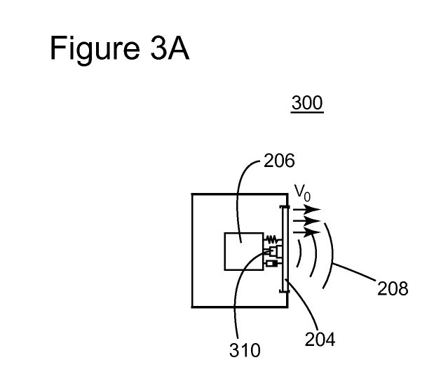

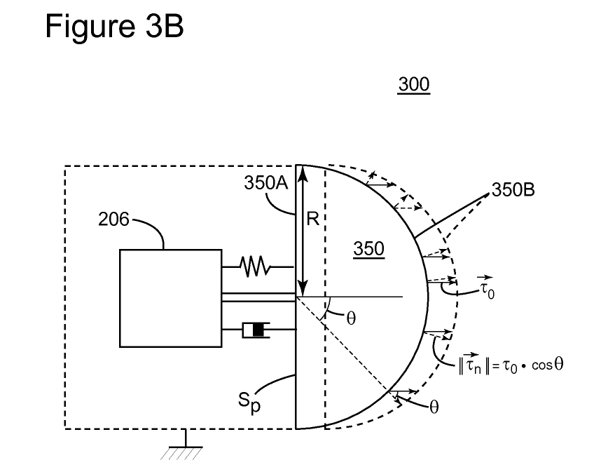

However, it is possible that the piston has a different shape, i.e., it is not a flat circular piston as illustrated in FIG. 3A. For example, FIG. 3B shows a vibratory source 300 that has a fixed enclosure (i.e., the enclosure does not move) and a piston 350 having a semi-spherical shape that moves relative to the enclosure. The novel concepts discussed herein also apply to other shapes. For the semi-spherical piston 350, the source strength Q is given by:

Q=∫∫_{S}Vₙ(r)dS=jω∫∫_{S}τₙ(r)dS, (8)

where τₙ is the normal displacement. The corresponding volume velocity, created by the hemi-spherical piston that moves with axial displacement τ₀, is given by:

Q=jω∫∫_{S}τ₀ cos θdS, (9)

where θ is the angle between the axial displacement τ₀ and the normal displacement τₙ for a given point on the piston surface. It can be shown that Q is equal to V₀×Sₚ, with Sₚ being the projected surface of the hemi-spherical piston on the piston's base 350A. In other words, although the shape of the piston is semi-spherical or may have another shape, the source strength is still given by the axial speed of the piston multiplied by the projection of the piston's area 350B on its base 350A. Thus, the far-field radiation of a hemi-spherical piston (or other shape, concave or convex) is similar (equivalent) to a flat piston.

Based on this observation, the sound pressure of an individual vibratory source may be extended to a vibratory source array that includes plural individual (single) vibratory sources. Further, because the vibratory system is small compared to the generated wavelength, it is possible to consider that each individual vibratory source 200 or 300 is a point source (source that emits a wavefield that is spherically symmetrical). One or more pistons (it is noted that the source may have one or more pistons, and FIG. 2A shows two pistons) may be equipped, as shown in FIG. 3A, with a sensor 310 (e.g., mono- or multi-axis accelerometer) for measuring axial piston acceleration. As already noted above, the measured piston's relative acceleration needs to be adjusted to determine the absolute acceleration. This is especially important if a source with a single piston is used as the housing of the source acts as a second piston, which means that the housing has a non-zero acceleration when the piston moves. Thus, the piston's absolute acceleration is the quantity that needs to be measured/calculated and to be used in the present equations.

For this kind of vibratory source, the radiated energy in the far-field, i.e., the far-field waveform, is directly proportional to the piston's absolute acceleration. Thus, the sound pressure Pᵢ of an i^{th} individual vibratory source, observed at a point rᵢ from piston i at a given time t, is given by:

$${P}_{i} ( {r}_{i} , t ) = \frac{ρ {A}_{i} ( t - \frac{{r}_{i}}{c} ) {S}_{i}}{4 π {r}_{i}} , \qquad ( 10 )$$

which is similar to equation (7) and in which c is the speed of sound in water. Note that the influence or interaction between the i^{th} source and other sources in the source array is captured by the absolute acceleration Aᵢ of the piston.

The above mathematical formula is true for a single (individual) vibratory source as discussed above. However, a practical marine vibrator array often contains dozens of individual vibratory sources for radiating sufficient acoustic power into the water and for achieving the directivity required for a selected frequency response. In addition, to achieve a specific bandwidth and to improve source efficiency, multi-level arrays may be used simultaneously.

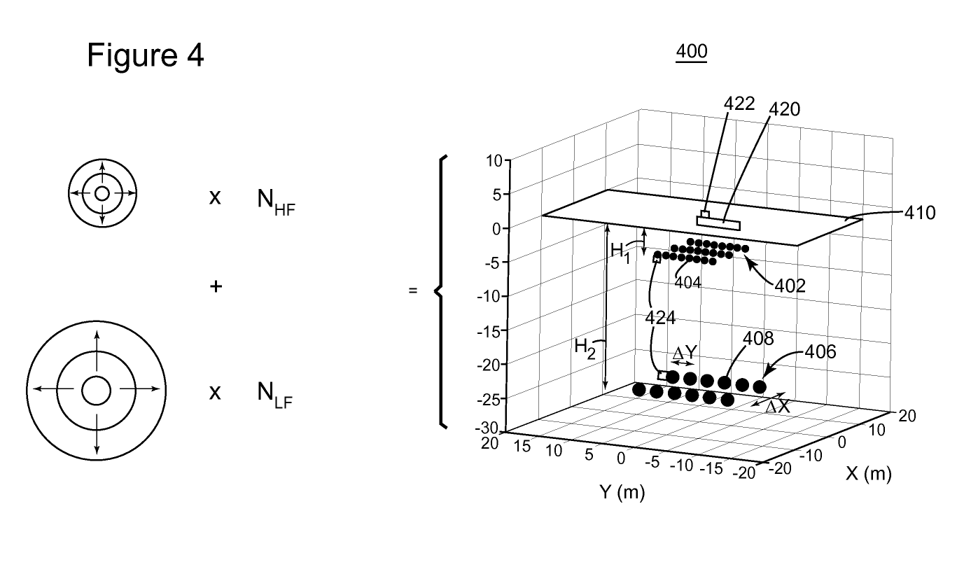

An example of a multi-level source array is shown in FIG. 4. The multi-level source array 400 includes a first array 402 of individual vibratory sources 404 (e.g., a source 200) and a second array 406 of individual vibratory sources 408. The individual vibratory sources 404 and 408 may be identical or different. They may emit the same frequency spectrum or different frequency spectra. The first array 402 may be located at a first depth H1 (from the sea surface 410) and the second array 406 may be located at a second depth H2. In one application, the individual vibratory sources 404 in the first array 402 may be distributed on a slanted line, on a curved line or along a parameterized line (e.g., a circle, parabola, etc.). The same is true for the second array 406.

Assuming that all N_{HF} individual vibratory sources 404 are located at the same depth H1 and emit a high frequency HF, and all N_{LF} individual vibratory sources 408 are located at the same depth H2 and emit a low frequency LF, the multi-level source array 400 may be modeled as a combination of N_{HF} monopoles having the frequency HF and N_{LF} monopoles having the frequency LF, as also illustrated in FIG. 4.

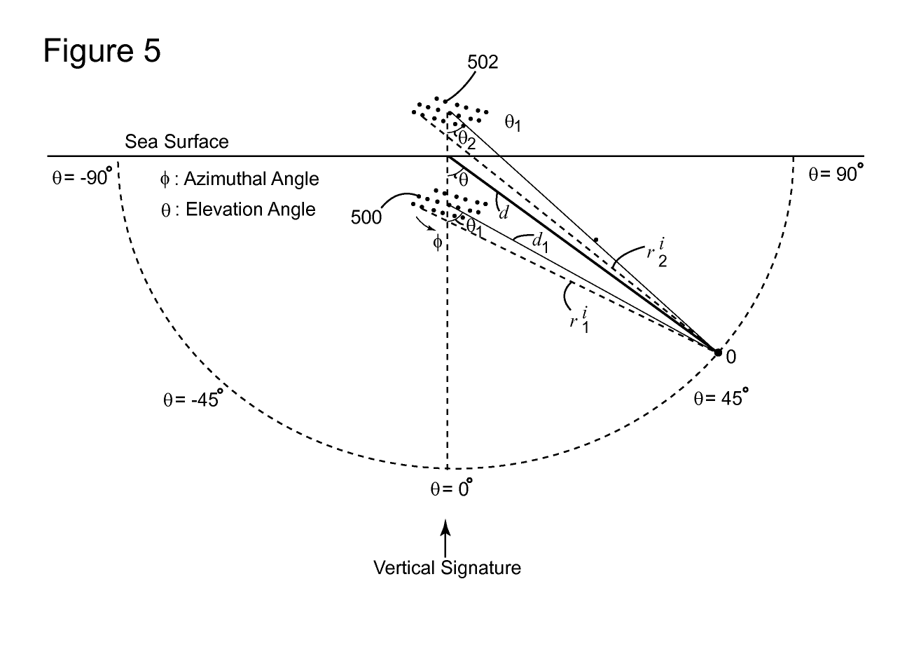

Considering the sea surface 410 as a plane reflector, each of the N_{LF}+N_{HF} seismic sources create additional virtual sources due to reflection at the sea/air interface. These virtual sources create additional signals (ghosts) which need to be considered when estimating the far-field signature. The strength of these additional signals from the virtual seismic sources depends on the distance from the i^{th} virtual piston to the predetermined observer point. Thus, the sound pressure level P(t, d) at a predetermined point (observer point O situated at distance d₁ from the center of the source array, see FIG. 5), needs to include the virtual sources, and can be expressed by taking into account the sound pressure Pᵢ (see equation (10)) generated by each individual vibratory source as follows:

$$P ( t , {d}_{1} ) = {\sum }_{k = 1}^{M} [ {\sum }_{i = 1}^{{N}_{k}} ( {P}_{i}^{k} + {RP}_{i}^{k} ) ] = {\sum }_{k = 1}^{M} [ {\sum }_{i = 1}^{{N}_{k}} ( \frac{ρ {A}_{i}^{k} ( t - \frac{{r}_{1}^{i}}{c} ) {S}_{i}^{k}}{4 π {r}_{1}^{i}} + R \frac{ρ {A}_{i}^{k} ( t - \frac{{r}_{2}^{i}}{c} ) {S}_{i}^{k}}{4 π {r}_{2}^{i}} ) ] , \qquad ( 11 )$$

where M is the number of levels (two in the example illustrated in FIG. 4), Nₖ is the number of pistons per level (2×N_{LF} and 2×N_{HF} for the above example), Aᵢ^{k} is the i^{th} piston's absolute acceleration from level k, Sᵢ^{k} is the i^{th} effective piston area (i.e., the projection of the area of the piston on its base as discussed above) from level k, and r₁ⁱ and r₂ⁱ are respectively the distances from the i^{th} piston and i^{th} virtual piston to the predetermined observer point O. Note that for this case, the reflection coefficient R is considered to be a constant. An overview of the geometry of the actual vibratory source 500 and the virtual vibratory source 502 is illustrated in FIG. 5.

The same equation can be written in the frequency domain so that a phase shift per piston φ₀ⁱ can be taken into account for phased array application. The equation in the frequency domain is:

$$P ( ω , {d}_{1} ) = {\sum }_{k = 1}^{M} [ {\sum }_{i = 1}^{{N}_{k}} ( \frac{ρ {A}_{i}^{k} ( ω ) {S}_{i}^{k}}{4 π {r}_{1}^{i}} {e}^{- j ( {kr}_{1}^{i} + {ϕ}_{0}^{i} )} + R \frac{ρ {A}_{i}^{k} ( ω ) {S}_{i}^{k}}{4 π {r}_{2}^{i}} {e}^{- j ( {kr}_{2}^{i} + {ϕ}_{0}^{i} )} ) ] , \qquad ( 12 )$$

where the term e^{jωt} is omitted for simplicity.

In one application, if a source array is not rigid (i.e., the distance between individual vibratory sources that make up the source array can change) or if the depth is not accurately controlled, it is necessary to obtain information about the positions of each individual vibratory source. This is required to achieve good accuracy of the distances estimates (r₁ⁱ and r₂ⁱ). The positions of each individual vibratory source may be obtained by using an external system for monitoring the sources' positions in the array, for example, by mounting GPS receivers 422 on the source floats 420, as illustrated in FIG. 4, and/or placing depth sensors 424 on the sources on each level.

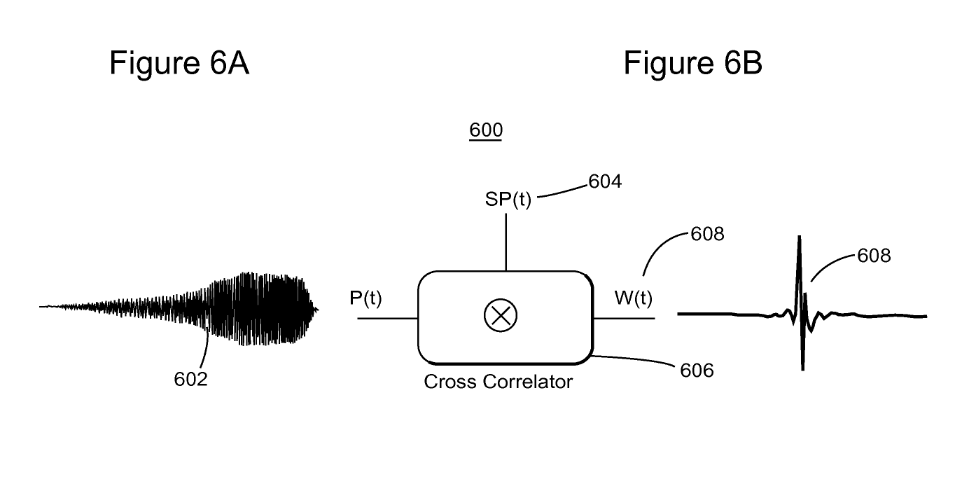

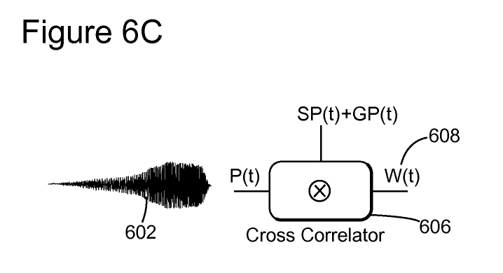

Thus, the sound pressure P(t, d) (also called far-field waveform) produced by all the individual vibratory sources and their virtual counterparts may be calculated with one of the equations discussed above. Having the far-field waveform for the source array, a corresponding far-field wavelet (time compressed element) can be derived by using a cross-correlation operation between the far-field waveform estimate and the pilots 604 used to drive both sub-arrays of sources (N_{LF}+N_{HF}). The far-field wavelet, in this exemplary embodiment, is then the far-field signature. Thus, the far-field signature is a generic name and it is valid if another mathematical device is used. This process is schematically shown in FIG. 6A, in which the far-field waveform P(t) 602 obtained along the vertical axis is cross-correlated in step 606 with the signal pilot or pilots SP(t) 604 to obtain the far-field wavelet W(t) 608, which is illustrated in FIG. 6B.

FIG. 6C illustrates another embodiment in which an additional step (comparing to the embodiment of FIG. 6A) is performed. The additional step takes into account ghost pilots GP(t) in the cross-correlation step 606, and thus, the input term includes the signal pilots SP(t) and the ghost pilots GP(t). A ghost pilot GP(t) may be, for example, the signal pilot SP(t) having its polarity reversed and time delayed depending on the depth. In this way, the deghosted far-field wavelet W(t) 608 can be estimated.

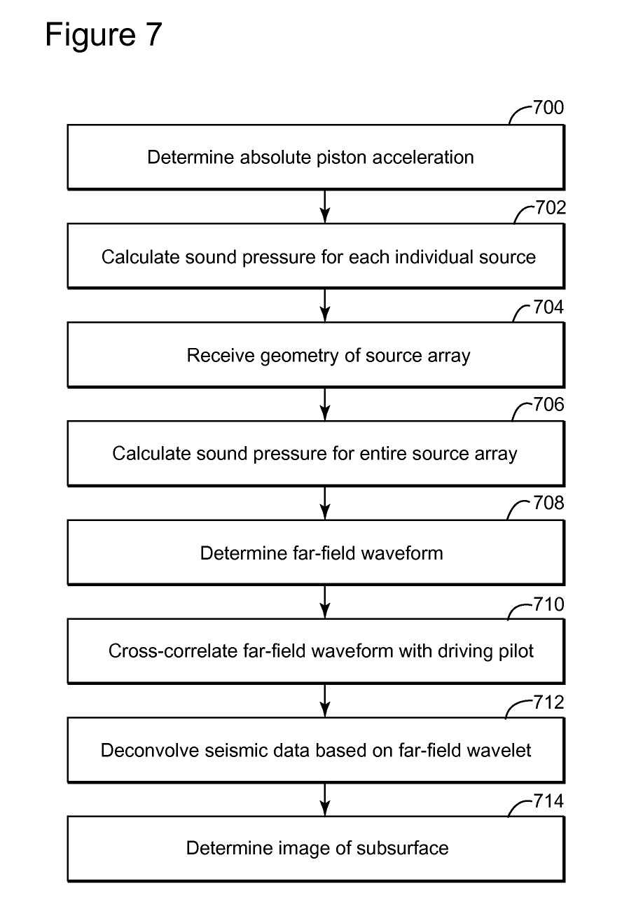

According to an exemplary embodiment, a method for determining the far-field signature of a marine seismic source, based on the teachings of the above embodiments, is now discussed with regard to FIG. 7. The method is discussed with reference to a seismic source that has a movable piston that generates the seismic waves. In step 700, the absolute acceleration of the piston is determined. This may be achieved by using a sensor or sensors mounted on/to the piston and/or actuator, or by estimating the acceleration from the driving signal that drives the seismic source.

If the seismic source includes plural individual vibratory sources, i.e., it is a seismic source array, a sound pressure for each of the individual vibratory sources may be calculated in step 702 based, for example, on formula (10). Another formula may be used if the vibratory seismic source is not well approximated by a monopole model as illustrated in FIG. 2B. The geometry of the seismic source array is received in step 704. The geometry may be fixed, i.e., the individual vibratory sources do not move relative to one another. In this case, the geometry of the seismic source array may be stored before the seismic survey and used as necessary to update the source array's far-field signature. However, if the seismic source array geometry is not fixed, the GPS receivers 422 and/or depth sensors 424 may periodically update the geometry of the seismic source array.

Based on the individual vibratory sources' sound pressures and the seismic source array geometry, the sound pressure for the entire seismic source array is calculated in step 706 (e.g., based on equations (11) and/or (12)). Based on this, the seismic source array's far-field waveform is calculated in step 708. In step 710, the far-field waveform is cross-correlated with the pilot signal driving the seismic source to obtain the far-field signature (e.g., the far-field wavelet). The far-field signature may be used in step 712 to deconvolve the recorded seismic data to improve the accuracy of the final result or to associate it with the seismic data recorded at the receiver to compensate for source signature effects. In step 714, an image of the surveyed subsurface may be formed based on the deconvolved seismic data.

One or more advantages associated with the novel far-field signature method discussed above are now considered. The novel method is scalable, i.e., it can be applied to any number of individual vibratory sources. Further, using the axial acceleration signal (absolute acceleration) of the individual vibratory source to determine the far-field signature, the interaction between pistons of different individual sources from the array is taken into account. In other words, this method captures the sound pressure generated by the individual source of interest and also the effect or influence (interaction) of all other individual sources on the considered source without capturing the sound pressure generated by the other individual sources of the array. This is true irrespective of whether the individual sources vibrate in a synchronous or asynchronous mode. The novel method discussed above is independent of the actuator technology.

Thus, the absolute piston acceleration used in this method can be used directly to compute the far-field signature at any point below the sea surface. The method using near-field sensors implies an additional step in the processing in order to get the well-known “notional near-field signature.” This additional step is not necessary in this method, thus simplifying the processing and reducing processing time.

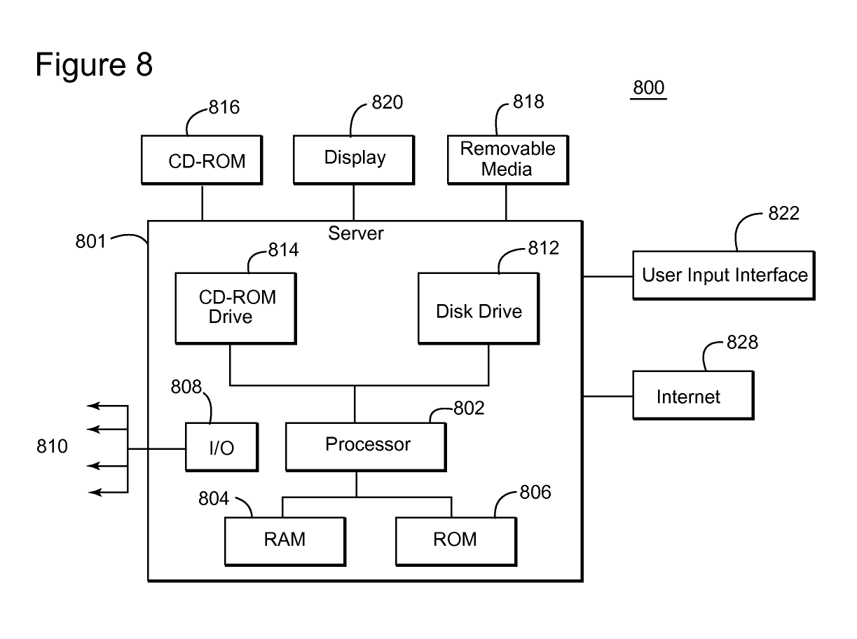

An example of a representative computing device capable of carrying out operations in accordance with the exemplary embodiments discussed above is illustrated in FIG. 8. Hardware, firmware, software or a combination thereof may be used to perform the various steps and operations described herein.

The exemplary computing device 800 suitable for performing the activities described in the exemplary embodiments may include server 801. Such a server 801 may include a central processor unit (CPU) 802 coupled to a random access memory (RAM) 804 and to a read-only memory (ROM) 806. The ROM 806 may also be other types of storage media to store programs, such as programmable ROM (PROM), erasable PROM (EPROM), etc. The processor 802 may communicate with other internal and external components through input/output (I/O) circuitry 808 and bussing 810, to provide control signals and the like. For example, the processor 802 may communicate with the sensors, electromagnetic actuator system and/or the pressure mechanism. The processor 802 carries out a variety of functions as is known in the art, as dictated by software and/or firmware instructions.

The server 801 may also include one or more data storage devices, including hard and floppy disk drives 812, CD-ROM drives 814, and other hardware capable of reading and/or storing information such as a DVD, etc. In one embodiment, software for carrying out the above-discussed steps may be stored and distributed on a CD-ROM 816, diskette 818 or other form of media capable of portably storing information. These storage media may be inserted into, and read by, devices such as the CD-ROM drive 814, the disk drive 812, etc. The server 801 may be coupled to a display 820, which may be any type of known display or presentation screen, such as LCD displays, plasma displays, cathode ray tubes (CRT), etc. A user input interface 822 is provided, including one or more user interface mechanisms such as a mouse, keyboard, microphone, touch pad, touch screen, voice-recognition system, etc.

The server 801 may be coupled to other computing devices, such as the equipment of a vessel, via a network. The server may be part of a larger network configuration as in a global area network (GAN) such as the Internet 828, which allows ultimate connection to the various landline and/or mobile client/watcher devices.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized, including hard disks, CD-ROMs, digital versatile discs (DVD), optical storage devices, or magnetic storage devices such a floppy disk or magnetic tape. Other non-limiting examples of computer-readable media include flash-type memories or other known types of memories.

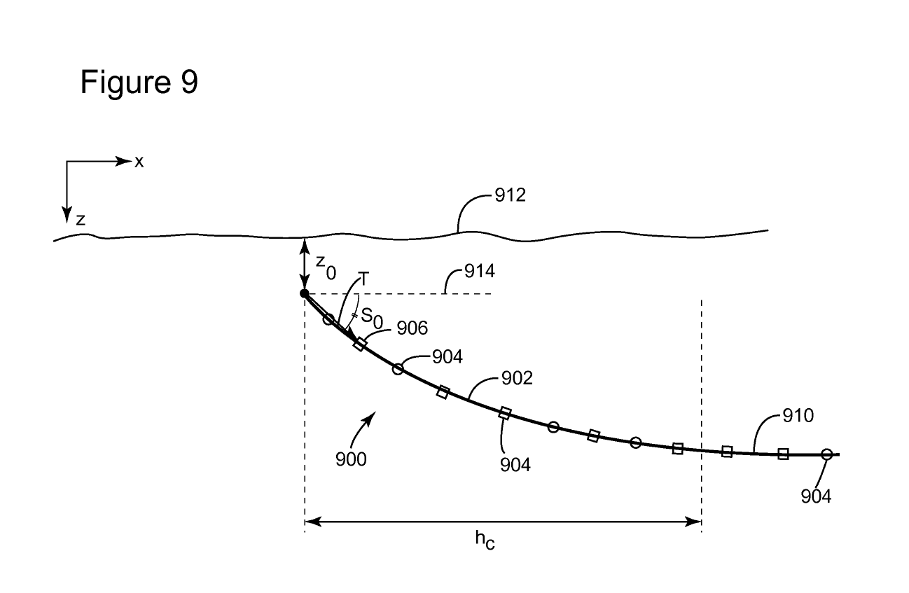

The above embodiments were discussed without specifying what type of seismic receivers are used to record the seismic data. In this sense, it is known in the art to use, for a marine seismic survey, streamers with seismic receivers that are towed by one or more vessels. The streamers may be horizontal or slanted or having a curved profile as illustrated in FIG. 9.

The curved streamer 900 of FIG. 9 includes a body 902 having a predetermined length, plural detectors 904 provided along the body, and plural birds 906 provided along the body for maintaining the selected curved profile. The streamer is configured to flow underwater when towed so that the plural detectors are distributed along the curved profile. The curved profile may be described by a parameterized curve, e.g., a curve described by (i) a depth z₀ of a first detector (measured from the water surface 912), (ii) a slope s₀ of a first portion T of the body with an axis 914 parallel with the water surface 912, and (iii) a predetermined horizontal distance h_{c} between the first detector and an end of the curved profile. Note that not the entire streamer has to have the curved profile. In other words, the curved profile should not be construed to always apply to the entire length of the streamer. While this situation is possible, the curved profile may be applied only to a portion 908 of the streamer. In other words, the streamer may have (i) only a portion 908 with the curved profile or (ii) a portion 908 having the curved profile and a portion 910 having a flat profile, the two portions being attached to each other.

The disclosed exemplary embodiments provide a method and a computing device for determining an improved far-field signature of a seismic source. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for calculating a far-field signature of a vibratory seismic source, the method comprising:
determining an absolute acceleration of a piston of the vibratory seismic source while the vibratory seismic source generates a seismic wave; and
calculating, based on the absolute acceleration of the piston, a far-field waveform of the vibratory seismic source at a given point (O) away from the vibratory seismic source.

2. The method of claim 1, further comprising:
cross-correlating the far-field waveform with a driving pilot signal of the vibratory seismic source to determine the far-field signature of the vibratory seismic source.

3. The method of claim 1, wherein the step of determining comprises:
measuring a relative acceleration of the piston with at least one sensor; and
calculating the absolute acceleration of the piston by taking into account an acceleration of vibratory seismic source.

4. The method of claim 3, wherein the at least one sensor has one component that is directly attached to the piston and one component that is directly attached to a housing of the vibratory seismic source and includes a Linear Variable Differential Transformer and its output is twice differentiated with time to determine the acceleration of the piston relative to the housing.

5. The method of claim 1, wherein the step of determining comprises:
calculating the acceleration of the piston relative to earth.

6. The method of claim 1, wherein the vibratory seismic source comprises an enclosure having first and second openings, first and second pistons configured to close the first and second openings, and an actuator system provided inside the enclosure and configured to simultaneously actuate the first and second pistons to generate the seismic wave.

7. The method of claim 1, wherein the step of calculating comprises:
calculating the far-field waveform as
$$P ( t , {d}_{1} ) = {\sum }_{k = 1}^{M} [ {\sum }_{i = 1}^{{N}_{k}} ( \frac{ρ {A}_{i}^{k} ( t - \frac{{r}_{1}^{i}}{c} ) {S}_{i}^{k}}{4 π {r}_{1}^{i}} + R \frac{ρ {A}_{i}^{k} ( t - \frac{{r}_{2}^{i}}{c} ) {S}_{i}^{k}}{4 π {r}_{2}^{i}} ) ] ,$$
where P is the far-field waveform, t is the time, d₁ is a distance between the seismic vibratory source and a point where the far-field waveform is calculated, ρ is the medium density, Aᵢ is the acceleration of the piston i, Sᵢ is the effective surface of the piston i, r₁ is d₁ if only a single seismic vibratory source is considered, R is a reflectivity of the air-water interface, and r₂ is a distance between (i) the point where the far-field waveform is calculated and (ii) a mirror position of the seismic vibratory source relative to the air-water interface.

8. The method of claim 1, further comprising:
associating the seismic data recorded with the plural receivers with a far-field signature calculated based on the far-field waveform to compensate for the vibratory seismic source signature effects.

9. The method of claim 8, further comprising:
displaying on a screen an image of a surveyed subsurface based on the recorded seismic data deconvolved based on the far-field signature.

10. The method of claim 1, wherein the driving signal is added to ghost pilots prior to being cross-correlated with the far-field waveform to obtain a deghosted far-field wavelet.

11. The method of claim 1, wherein the far-field waveform calculated at a selected point is related (i) to a sound pressure generated by the seismic vibratory source and effects on the piston of the seismic vibratory source from neighboring vibratory sources, (ii) but not to sound pressures directly generated by the neighboring vibratory sources.

12. The method of claim 1, wherein a shape of the piston of the seismic vibratory source is hemi-spherical.

13. A method for calculating a far-field signature of a vibratory seismic source array, the method comprising:
determining absolute accelerations of pistons of individual vibratory seismic sources of the vibratory seismic source array while the individual vibratory seismic sources generate seismic waves; and
calculating, based on the absolute accelerations of the pistons, a far-field waveform of the vibratory seismic source array at a given point (O) away from the vibratory seismic source array.

14. The method of claim 13, further comprising:
cross-correlating the far-field waveform with a driving pilot signal of the vibratory seismic source array to determine a far-field signature of the vibratory seismic source array.

15. The method of claim 12, further comprising:
receiving information relating to a geometry of the vibratory source array; and
using the geometry to calculate the far-field waveform.

16. The method of claim 12, wherein the step of calculating comprises:
calculating the far-field waveform as
$$P ( t , {d}_{1} ) = {\sum }_{k = 1}^{M} [ {\sum }_{i = 1}^{{N}_{k}} ( \frac{ρ {A}_{i}^{k} ( t - \frac{{r}_{1}^{i}}{c} ) {S}_{i}^{k}}{4 π {r}_{1}^{i}} + R \frac{ρ {A}_{i}^{k} ( t - \frac{{r}_{2}^{i}}{c} ) {S}_{i}^{k}}{4 π {r}_{2}^{i}} ) ] ,$$
where P is the far-field waveform, t is the time, d₁ is a distance between a center of the seismic vibratory source array and a point where the far-field waveform is calculated, ρ is the medium density, Aᵢ is the acceleration of the piston i, Sᵢ is the effective surface of the piston i, r₁ is distance between the ith individual seismic vibratory source and the point, R is a reflectivity of the air-water interface, and r₂ is a distance between (i) the point where the far-field waveform is calculated and (ii) a mirror position of the individual seismic vibratory source relative to the air-water interface.

17. The method of claim 14, further comprising:
deconvolving the seismic data recorded with plural receivers based on the far-field signature; and
displaying on a screen an image of a surveyed subsurface based on the deconvolved seismic data.

18. A computing device for calculating a far-field signature of a vibratory seismic source, the computing device comprising:
an interface for receiving an absolute acceleration of a piston of the vibratory seismic source while the vibratory seismic source generates a seismic wave; and
a processor connected to the interface and configured to,
calculate, based on the absolute acceleration of the piston, a far-field waveform of the vibratory seismic source at a given point (O) away from the vibratory seismic source, and
cross-correlate the far-field waveform with a driving pilot signal of the vibratory seismic source to determine the far-field signature of the vibratory seismic source.

19. The computing device of claim 18, wherein the vibratory seismic source comprises an enclosure having first and second openings, first and second pistons configured to close the first and second openings, and an actuator system provided inside the enclosure and configured to simultaneously actuate the first and second pistons to generate the seismic wave.

20. The computing device of claim 18, wherein the processor is configured to:
calculate the far-field waveform based on formula
$$P ( t , {d}_{1} ) = {\sum }_{k = 1}^{M} [ {\sum }_{i = 1}^{{N}_{k}} ( \frac{ρ {A}_{i}^{k} ( t - \frac{{r}_{1}^{i}}{c} ) {S}_{i}^{k}}{4 π {r}_{1}^{i}} + R \frac{ρ {A}_{i}^{k} ( t - \frac{{r}_{2}^{i}}{c} ) {S}_{i}^{k}}{4 π {r}_{2}^{i}} ) ] ,$$
where P is the far-field waveform, t is the time, d₁ is a distance between the seismic vibratory source and a point where the far-field waveform is calculated, ρ is the medium density, Aᵢ is the acceleration of the piston i, Sᵢ is the effective surface of the piston i, r₁ is d₁ if only a single seismic vibratory source is considered, R is a reflectivity of the air-water interface, and r₂ is a distance between (i) the point where the far-field waveform is calculated and (ii) a mirror position of the seismic vibratory source relative to the air-water interface.

21. The computing device of claim 18, wherein the processor is configured to:
associate the seismic data recorded with the plural receivers with a far-field signature calculated based on the far-field waveform to compensate for the vibratory seismic source signature effects.

22. The computing device of claim 18, wherein the driving signal is added to ghost pilots prior to being cross-correlated with the far-field waveform to obtain a deconvolved far-field wavelet.
